(19) United States
(12) Patent Application Publication
(10) Pub. No.: US 2010/0220083 A1
(43) Pub. Date: Sep. 2, 2010

(54) DRIVING APPARATUS OF 2D/3D IMAGE DISPLAY APPARATUS

(76) Inventor: Jung-Woo Kim, Seoul (KR)

Correspondence Address: HYUN JONG PARK;Park & Associates IP Law LLC, 265 Bic Drive, Suite 106, Milford, CT, 06461, US

(21) Appl. No.: 12/161,813

(22) PCT Filed: Jan. 23, 2007
(86) PCT No.: PCT/KR2007/000400

§ 371 Date: Jul. 23, 2008

(30) Foreign Application Priority Data
Jan. 23, 2006 (KR) 10-2006-0007030

(51) Int. Cl. G06F 3/038

(52) U.S. Cl. 345/211

(57) ABSTRACT

There are provided a driver unit of a 2D/3D image display apparatus employing a single power supply system and a 2D/3D image display apparatus having the driver unit. In the driver unit of the 2D/3D image display apparatus, the driver unit supplies a 3D image display panel driving signal to the 3D image display panel. The driver unit includes: a single power supply unit which generates a single source voltage; and a control circuit which is connected to the single power supply unit and has first and second output terminals connected to the 3D image display panel. The control circuit outputs first and second positive voltage pulse signals having a phase difference of 90 degree through the first output terminal and the second output terminal. Here, the 3D image display panel driving signal is a differential signal between the first and second positive voltage pulse signals.

### TECHNICAL FIELD

The present invention relates to a driver unit of a 2D/3D image display apparatus, and more particularly, to a driver unit of a 2D/3D image display apparatus using a single power supply system and a 2D/3D image display apparatus employing the driver unit.

### BACKGROUND ART

2D/3D image display apparatuses employing an LCD have been actively studied and developed. In the following description, a “2D/3D image display apparatus” means a display apparatus which can selectively display a 2D image and a 3D image. Such a 2D/3D image display apparatus is used in a monitor of a computer or a mobile phone.

FIG. 1 is a block diagram schematically illustrating a known 2D/3D image display apparatus. The 2D/3D image display apparatus includes a driver unit 100 and a 3D image display panel 200. The 3D image display panel 200 includes a parallax barrier formed of a TN LCD or the like. The parallax barrier serves to display two 2D images (left-eye 2D image and right-eye 2D image) as if they were a 3D image (that is, stereoscopic image).

The invention relates to a driver unit 100 for driving and controlling a 3D image display panel 200. The control of the 3D image display panel has an influence on a 3D effect (that is, stereoscopic effect). Particularly, a power supply system related to the driving and controlling of the 3D image display panel has a direct influence on image quality of a 3D image.

FIGS. 2 and 3 are waveform diagrams of control signals input to the 3D image display panel. The control signals input to the 3D image display panel roughly include two types. A first type control signal is a 2D/2D image display switching signal and a second type control signal is a 3D image display panel driving signal. FIGS. 2 and 3 show waveform diagrams of the 2D/3D image display switching signal and the 3D image display panel driving signal, respectively.

Referring to FIG. 2, a 2D/3D image display switching signal 2D/3D_CONVERT is a control signal as an on/off signal for displaying a 3D image in an on-state signal period (that is, 3D image display mode) and displaying a 2D image in an off-state signal period (that is, 2D display mode).

The 2D/3D image display switching signal 2D/3D_CONVERT can be supplied to the control circuit 120 from the outside. In this case, the 2D/3D image display switching signal 2D/3D_CONVERT can be supplied from an RS-232C port of a predetermined external device such as a personal computer. The 2D/3D image display switching signal 2D/3D_CONVERT supplied to the control circuit 120 is input to the 3D image display panel 200 via predetermined process steps.

Alternatively, the 2D/3D image display switching signal 2D/3D_CONVERT may be supplied directly to the 3D image display panel 200 by means of an operation of a predetermined switch mounted on a 2D/3D image display apparatus such as a monitor or a mobile phone.

Referring to FIG. 3, the 3D image display panel driving signal 3D_DRIVE is a control signal as a pulse signal for driving the 3D image display panel in the 3D image display mode in which the 2D/3D image display switching signal 2D/3D_CONVERT is kept in the on state.

A known configuration for generating the 3D image display panel driving signal 3D_DRIVE is now described.

Referring to FIG. 1 again, the 2D/3D image display apparatus includes the driver unit 100 and the 3D image display panel 200.

In the known 2D/3D image display apparatus, the driver unit 100 includes a single power supply unit 110, a control circuit 120 which is connected to the single power supply unit 110 and supplied with a single source voltage, a dual power supply unit 130 which is connected to the single power supply unit 110 and supplied with the single source voltage, and a dual voltage pulse generator 140 which is connected to the control circuit 120 and the dual power supply unit 130 and supplied with a dual voltage pulse generator activation signal and a dual voltage signal therefrom, respectively. The 3D image display panel driving signal from the dual voltage pulse generator 140 is input to the 3D image display panel 200.

The single power supply unit 110 supplies a driving power for the control circuit 120 and the dual power supply unit 130. The control circuit 120 is formed of a micro controller unit (MCU). The MCU is a kind of control circuit and thus cannot control directly the dual voltage signal output from the dual power supply unit 130. Accordingly, the dual voltage pulse generator 140 which can be controlled by a digital control circuit is required.

The dual voltage pulse generator 140 connected to the control circuit 120 and the dual power supply unit 130 and supplied with the dual voltage pulse generator activation signal and the dual voltage signal outputs the 3D image display panel driving signal 3D_DRIVE shown in FIG. 3 to the 3D image display panel 200.

More specifically, the control circuit 120 outputs the dual voltage pulse generator activation signal from one output terminal GPIO. The dual voltage pulse generator 140 is turned on or off in accordance with the dual voltage pulse generator activation signal.

When the dual voltage pulse generator activation signal is in the on state, the dual voltage pulse generator 140 generates a pulse, that is, the 3D image display panel driving signal 3D_DRIVE, to activate the 3D image display panel 200. When the dual voltage pulse generator activation signal is in the off state, the dual voltage pulse generator 140 generates an off signal of 0 V to deactivate the 3D image display panel 200. In this case, a 2D image is displayed.

The reason for using the dual voltage pulse generator 140 in the known driver unit 100 is that the control circuit 120, that is, the MCU, is a digital control circuit for controlling digital signals of 1 and 0 and thus cannot control directly the dual voltage signals of +/−V. Accordingly, the dual voltage pulse generator 140 serves to control directly the dual voltage sources and to generate actual pulses.

As described above, the driver unit of the known 2D/3D image display apparatus includes a dual power supply unit 130 for generating the dual voltage signal. Since the control circuit 120 formed of the digital control circuit cannot control directly the dual voltage signal output from the dual power supply unit 130, the dual voltage pulse generator 140 is additionally required.

Accordingly, the driver unit of the known 2D/3D image display apparatus has a complicated configuration and thus is not suitable for a mobile phone or the like.

A driver unit including only a single power supply unit without using the dual power supply unit can be considered to solve the above-mentioned problems. However, when a single voltage signal (DC voltage signal) output from the single power supply unit is used as the 3D image display panel driving signal 3D_DRIVE, a charging phenomenon occurs in the 3D image display panel 200, thereby causing a problem with damage of the 3D image display panel 200. In addition, ghost increases in an image displayed on the 3D image display panel 200 and a stereoscopic effect and brightness decreases, thereby causing a problem with deterioration in image quality. Since the MCU as a control circuit should generate a pulse signal in real time, there is caused a problem that a load on the MCU increases or that an expensive high-performance MCU should be used. Accordingly, it has been considered that a configuration in which the driver unit is formed of only the single power supply unit is not applicable to the 3D image display panel 200 in practice.

Therefore, in the related art, as described above, a driver unit including a dual power supply unit for generating a dual voltage signal has been used. By employing the known driver unit, the charging phenomenon can be suppressed to prevent the damage of the 3D image display panel and the decrease in ghost and the image quality can be enhanced due to the increase in stereoscopic effect and brightness.

The dual voltage pulse control can solve or greatly alleviate the problems of the single voltage pulse control, but additionally requires the dual power supply unit. Since the size of the dual power supply unit is great, it is not easy to fit the dual power supply unit to a small-sized product such as a mobile phone. In addition, even when the dual power supply unit can be fitted thereto, the circuit configuration is complicated to increase the cost for the product.

Furthermore, the use of the dual power supply unit can decrease the ghost and increase the stereoscopic effect, compared with a case where only the single power supply unit is used. However, when the dual voltage values of the dual power supply unit, that is, the power supply circuit, has an error, the ghost increases and the stereoscopic effect decreases, thereby causing a problem with a need for a higher precision power supply circuit. There are also difficulties in design and manufacture that a slew rate should be sufficiently considered in designing the driver circuit.

### DISCLOSURE OF THE INVENTION

### Technical Goal

A goal of the invention for solving the above-mentioned problems is to provide a driver unit of a 2D/3D image display apparatus employing a single power supply system.

Another goal of the invention is to provide a 2D/3D image display apparatus having a driver unit employing a single power supply system.

### Technical Solution

According to a first aspect of the invention, there is provided a driver unit of a 2D/3D image display apparatus including a 3D image display panel, wherein the driver unit supplies a 3D image display panel driving signal to the 3D image display panel, wherein the driver unit includes: a single power supply unit which generates a single source voltage; and a control circuit which is connected to the single power supply unit and has first and second output terminals connected to the 3D image display panel, wherein the control circuit outputs first and second positive voltage pulse signals having a phase difference of 90 degree through the first output terminal and the second output terminal, and wherein the 3D image display panel driving signal is a differential signal between the first and second positive voltage pulse signals.

According to a second aspect of the invention, there is provided a driver unit of a 2D/3D image display apparatus including a 3D image display panel, wherein the driver unit supplies a 3D image display panel driving signal to the 3D image display panel, wherein the driver unit includes: a single power supply unit which generates a single source voltage; a control circuit which is connected to the single power supply unit and generates a first pulse signal; a single voltage pulse generator which is connected to the control circuit, is turned on or off in accordance with the first pulse signal, and generates a second pulse signal as a single positive voltage pulse signal; and an inverter circuit which is connected to an output terminal of the single voltage pulse generator and inverts the second pulse signal, wherein the output terminal of the single voltage pulse generator and an output terminal of the inverter circuit are connected to the 3D image display panel, and wherein the 3D image display panel driving signal is a differential signal between the second pulse signal from the output terminal of the single voltage pulse generator and an output signal from the output terminal of the inverter circuit.

According to a third aspect of the invention, there is provided a driver unit of a 2D/3D image display apparatus including a 3D image display panel, wherein the driver unit supplies a 3D image display panel driving signal to the 3D image display panel, wherein the driver unit includes: a single power supply unit which generates a single source voltage; a control circuit which is connected to the single power supply unit and generates a positive pulse signal; and an inverter circuit which is connected to an output terminal of the control circuit and inverts the positive pulse signal, wherein the output terminal of the control circuit and an output terminal of the inverter circuit are connected to the 3D image display panel, and wherein the 3D image display panel driving signal is a differential signal between the positive pulse signal from the output terminal of the control circuit and an output signal from the output terminal of the inverter circuit.

The control circuit may be supplied with a 2D/3D image display switching signal.

The 2D/3D image display switching signal may be supplied from a predetermined external device.

The 3D image display panel may be supplied with the 2D/3D image display switching signal.

The 2D/3D image display switching signal may be supplied from a predetermined switch.

According to a fourth aspect of the invention, there is provided a 2D/3D image display apparatus having the above-mentioned driver unit.

### BRIEF DESCRIPTION OF THE DRAWINGS

FIG. 1 is a block diagram schematically illustrating a known 2D/3D image display apparatus.

FIG. 2 is a waveform diagram of a 2D/3D image display switching signal.

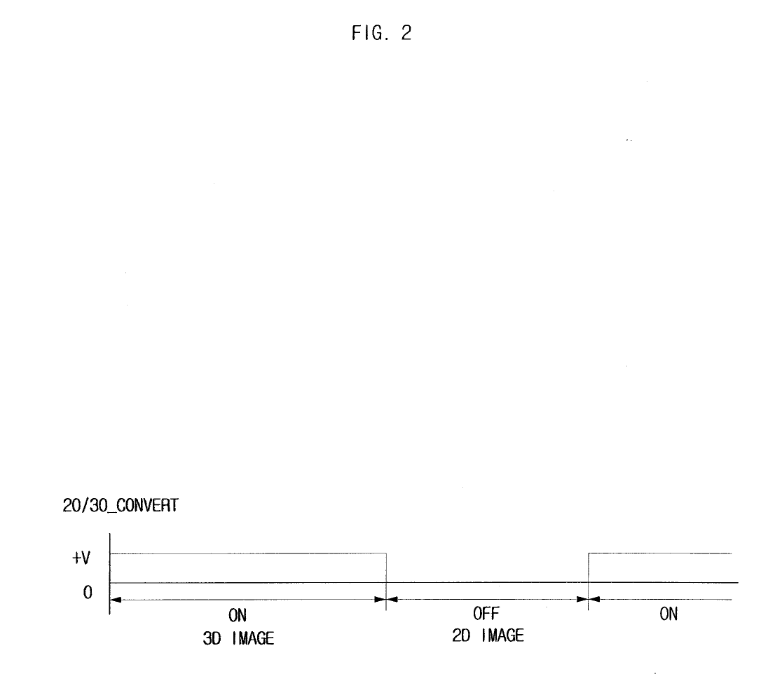

FIG. 3 is a waveform diagram illustrating a 3D image display panel driving signal.

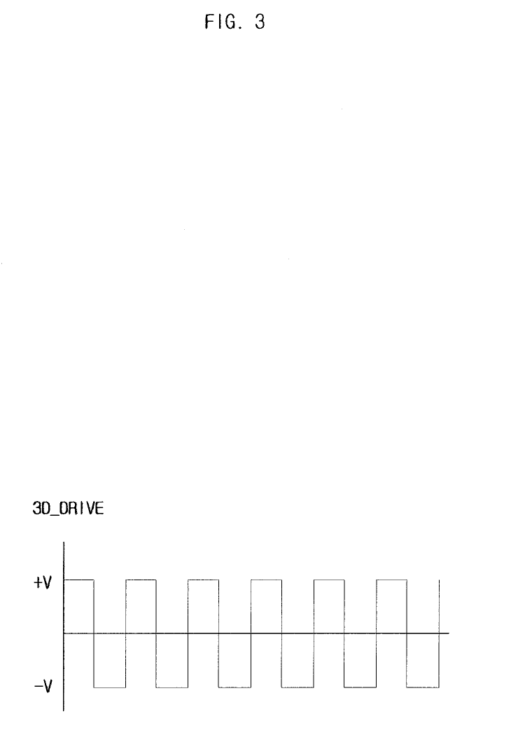

FIG. 4 is a block diagram schematically illustrating a driver unit of a 2D/3D image display apparatus according to a first embodiment of the invention.

FIG. 5 is a waveform diagram of output signals and a 3D image display panel driving signal of a control circuit in a driver unit of the 2D/3D image display apparatus according to the first embodiment of the invention.

FIG. 6 is a diagram illustrating a flow of current responsive to the 3D image display panel driving circuit input from the control circuit of the 2D/3D image display apparatus according to the first embodiment of the invention.

FIG. 7 is a block diagram schematically illustrating a driver unit of a 2D/3D image display apparatus according to a second embodiment of the invention.

FIG. 8 is a block diagram schematically illustrating a driver unit of a 2D/3D image display apparatus according to a third embodiment of the invention.

### DESCRIPTION OF THE EXEMPLARY EMBODIMENTS

In order to clearly understand the present invention, operational advantages of the invention, and objects achieved by embodiments of the invention, the accompanying drawings and descriptions exemplifying the exemplary embodiments of the invention should be referred to.

Hereinafter, the exemplary embodiments of the invention will be described in detail with reference to the accompanying drawings. The same reference numerals in the drawings denote the same elements.

A driver unit of a 2D/3D image display apparatus according to the exemplary embodiments of the invention will be now described with the accompanying drawings.

### First Embodiment

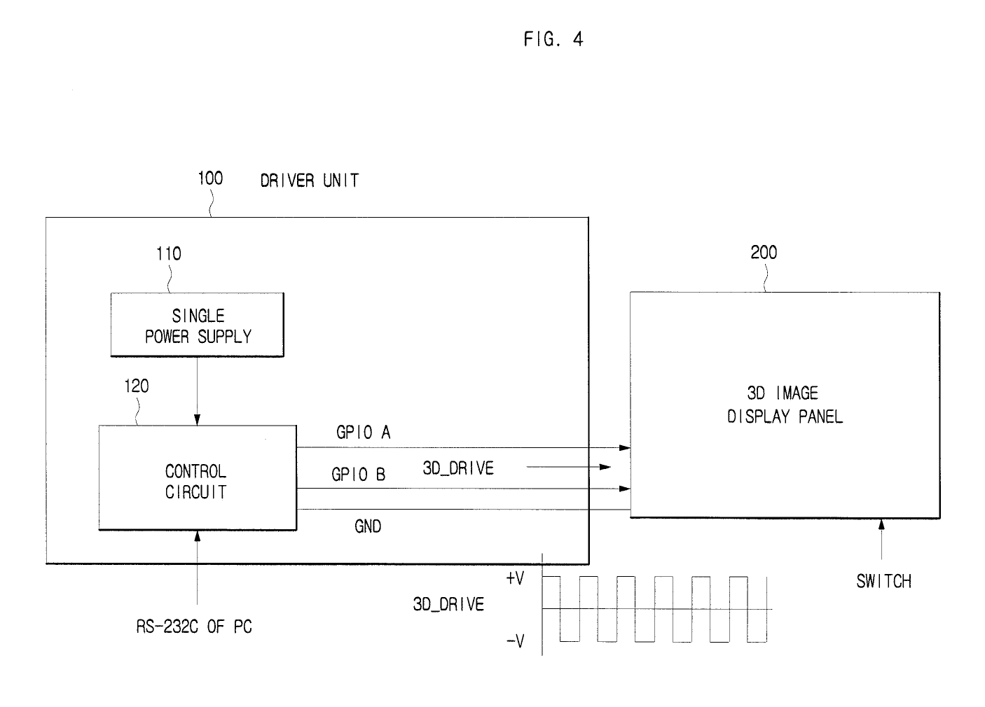

FIG. 4 is a block diagram schematically illustrating a driver unit of a 2D/3D image display apparatus according to a first embodiment of the invention.

In the first embodiment of the invention, the 2D/3D image display apparatus includes a driver unit 100 and a 3D image display panel 200. The driver unit 100 supplies a 3D image display panel driving signal 3D_DRIVE to the 3D image display panel 200.

The configuration of the driver unit 100 according to the first embodiment of the invention will be now described in more detail.

The driver unit 100 includes a single power supply unit 110 which generates a single source voltage and a control circuit 120 which is connected to the single power supply unit 110 and which has first and second output terminals connected to the 3D image display panel 300, respectively.

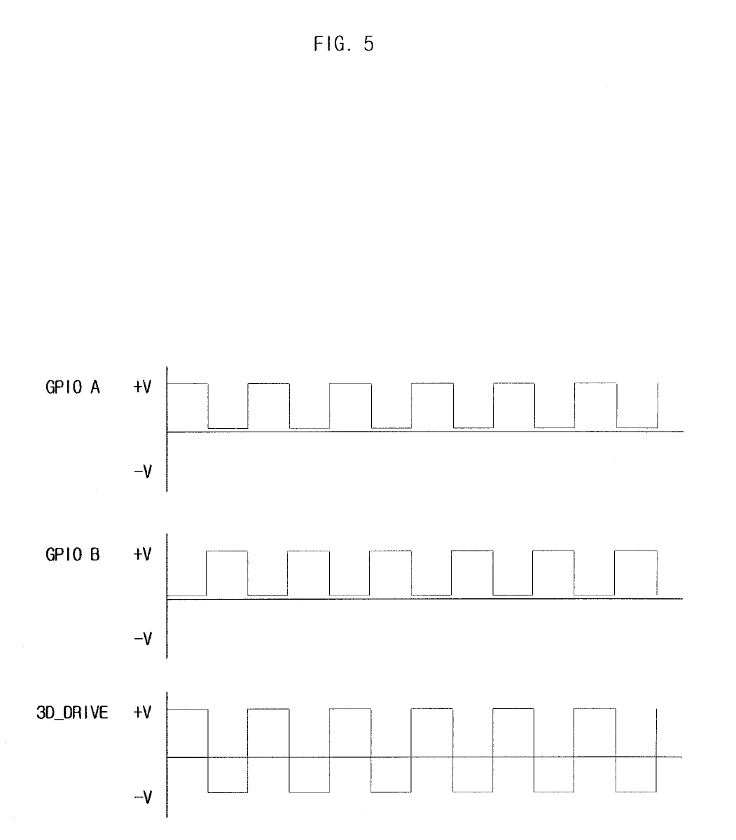

The control circuit 120 outputs first and second positive voltage pulse signals having a phase difference of 90 degree through the first output terminal GPIO A and the second output terminal GPIO B. In FIG. 5, the first and second positive voltage pulse signals having a phase difference of 90 degree are shown in FIG. 5.

The 3D image display panel driving signal 3D_DRIVE is a differential signal between the first and second positive voltage pulse signals. The 3D image display panel driving signal 3D_DRIVE is shown in FIG. 5.

According to the first embodiment of the invention, the first and second positive voltage pulse signals having a phase difference of 90 degree are generated from two output terminals GPIO A and GPIO B of the control circuit 120. Referring to FIG. 5, since the 3D image display panel driving signal 3D_DRIVE is the differential signal between the first and second positive voltage pulse signals, it is a pulse signal having the maximum magnitude of +V and the minimum magnitude of −V.

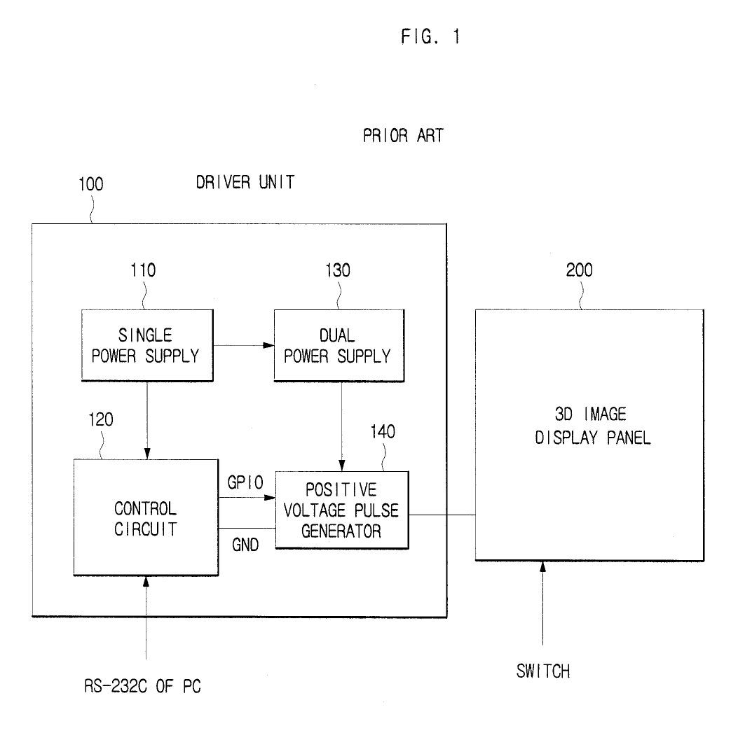

Since the first and second positive voltage pulse signals output from the output terminals GPIO A and GPIO B control directly the 3D image display panel 200, a voltage +V and a voltage −V are generated as described with reference to FIG. 1, that is, as the case where the dual power supply unit is used.

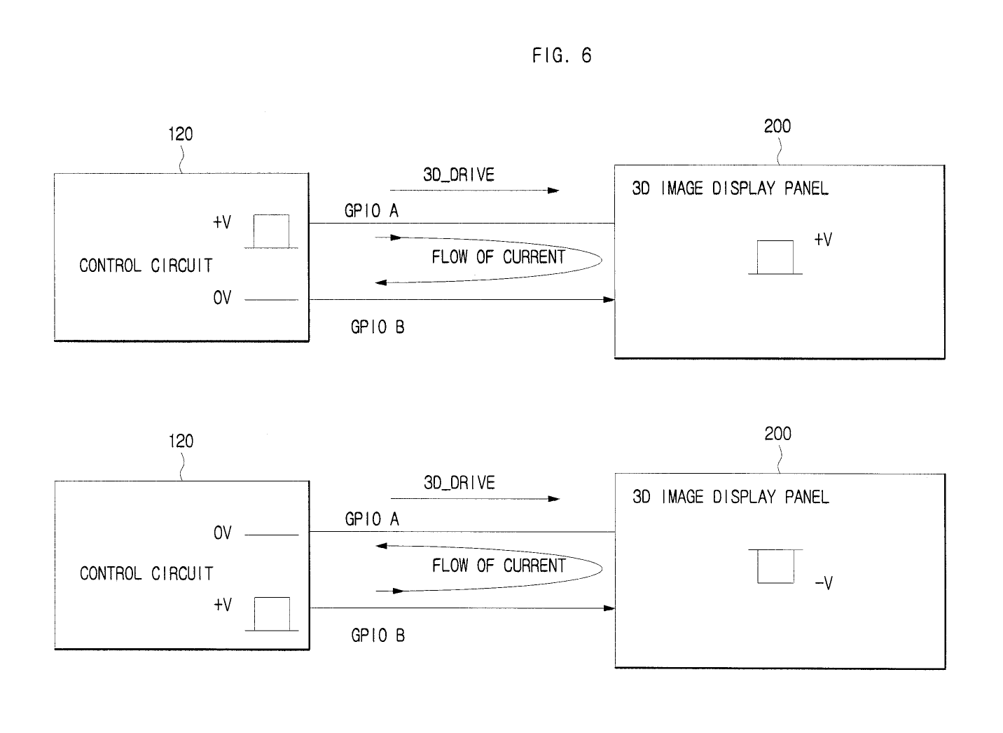

FIG. 6 is a diagram illustrating a flow of current corresponding to the 3D image display panel driving signal input from the 2D/3D image display apparatus according to the first embodiment of the invention. As shown in the figure, when the voltage pulse of +V is input, a forward flow of current occurs and when the voltage pulse of −V is input, a backward flow of current occurs.

That is, when the first output terminal GPIO A is in a pulse state of 1 (+V) and the second output terminal GPIO B is in a pulse state of 0 (0V), the current flows from the first output terminal GPIO A to the second output terminal GPIO B (forward flow of current). At this time, the 3D image display panel 200 is supplied with the voltage +V obtained by subtracting the second output terminal voltage (0V) from the first output terminal voltage (+V), as the 3D image display panel driving signal 3D_DRIVE.

Similarly, when the first output terminal GPIO A is in a pulse state of 0 (0V) and the second output terminal GPIO B is in a pulse state of 1 (+V), the current flows from the second output terminal GPIO B to the first output terminal GPIO A (backward flow of current). At this time, the 3D image display panel 200 is supplied with the voltage −V obtained by subtracting the second output terminal voltage (+V) from the first output terminal voltage (0V), as the 3D image display panel driving signal 3D_DRIVE.

As described above, according to the first embodiment of the invention, it is possible to supply dual voltage driving signals of +V and −V to the 3D image display panel 200.

On the other hand, a 2D/3D image display switching signal 2D/3D_CONVERT can be supplied to the driver unit 100 or the 3D image display panel 200.

When the 2D/3D image display switching signal 2D/3D_CONVERT is supplied to the driver unit 100, the 2D/3D image display switching signal 2D/3D_CONVERT is supplied preferably from an RS-232C of a predetermined external device. On the other hand, when 2D/3D image display switching signal 2D/3D_CONVERT is supplied to the 3D image display panel 200, the 2D/3D image display switching signal 2D/3D_CONVERT is supplied preferably from a predetermined switch.

According to the first embodiment of the invention, since the dual voltage driving signals can be supplied to the 3D image display panel without using a dual voltage supply unit, it is possible to reduce ghost of an image and to enhance a stereoscopic effect of the image. Since the digital control circuit (MCU) controls directly the output terminals GPIO, it is possible to perform an accurate control operation without considering a slew rate. Since only the single power supply unit is used, high precision is not required for a power supply circuit and cost for a product can be reduced with a simple circuit configuration.

### Second Embodiment

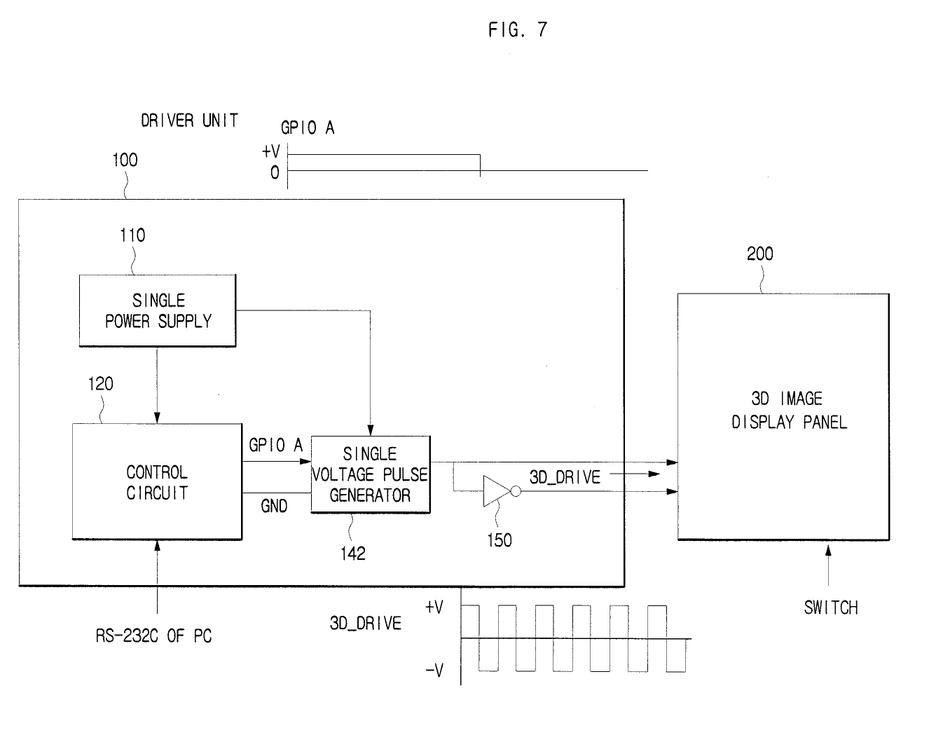

FIG. 7 is a block diagram schematically illustrating a driver unit of a 2D/3D image display apparatus according to a second embodiment of the invention.

In the second embodiment of the invention, the 2D/3D image display apparatus includes a driver unit 100 and a 3D image display panel 200. Similarly to the first embodiment, the driver unit 100 supplies a 3D image display panel driving signal 3D_DRIVE to the 3D image display panel 200.

According to the second embodiment of the invention, the driver unit 100 includes a single power supply unit 110 which generates a single source voltage, a control circuit 120 which is connected to the single power supply unit 110 and which generates a first pulse signal; a single voltage pulse generator which is connected to the control circuit 120, which is turned on or off in accordance with the first pulse signal, and which generates a second pulse signal as a single positive voltage pulse signal, and an inverter circuit 150 which is connected to an output terminal of the single voltage pulse generator 142 and which inverts the second pulse signal.

Since the output terminal of the single voltage pulse generator 142 and an output terminal of the inverter circuit 150 are connected to the 3D image display panel 300, the 3D image display panel driving signal 3D_DRIVE is a differential signal between the second pulse signal from the output terminal of the single voltage pulse generator 142 and an output signal from the output terminal of the inverter circuit 150.

In the second embodiment of the invention, the control signal 120 supplied only an on/off signal for activating the single voltage pulse generator 142 and the single voltage pulse generator 142 generates the substantial 3D image display panel driving signal 3D_DRIVE.

That is, since the second pulse signal from the output terminal of the single voltage pulse generator 142 and the output signal from the output terminal of the inverter circuit 150 are positive voltage pulse signals having a phase difference of 90 degree, the 3D image display panel driving signal 3D_DRIVE as a differential signal therebetween has the waveform shown in FIG. 5, similarly to the first embodiment.

According to the second embodiment of the invention, the voltage +V and the voltage −V can be generated without using a dual power supply unit, thereby obtaining the same advantage as the first embodiment.

On the other hand, in the second embodiment of the invention, the 2D/3D image display switching signal 2D/3D_CONVERT can be supplied to the driver unit 100 or the 3D image display panel 200, similarly to the first embodiment.

### Third Embodiment

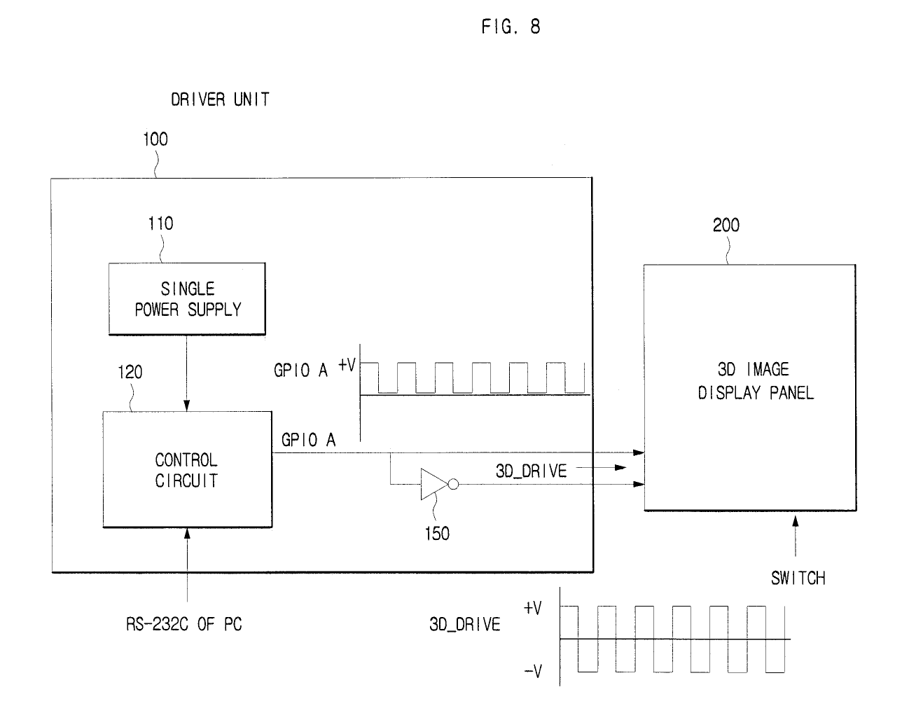

FIG. 8 is a block diagram schematically illustrating a driver unit of a 2D/3D image display apparatus according to a third embodiment of the invention.

In the third embodiment of the invention, the 2D/3D image display apparatus includes a driver unit 100 and a 3D image display panel 200. Similarly to the first and second embodiments, the driver unit 100 supplies a 3D image display panel driving signal 3D_DRIVE to the 3D image display panel 200.

According to the third embodiment of the invention, the driver unit 100 includes a single power supply unit 110 which generates a single source voltage, a control circuit 120 which is connected to the single power supply unit 110 and which generates a positive pulse signal, and an inverter circuit 150 which is connected to an output terminal of the control circuit 120 and which inverts the positive pulse signal.

Since the output terminal of the control circuit 120 and an output terminal of the inverter circuit 150 are connected to the 3D image display panel 200, the 3D image display panel driving signal 3D_DRIVE is a differential signal between the positive pulse signal from the output terminal of the control circuit 120 and an output signal from the output terminal of the inverter circuit 150.

In the third embodiment of the invention, the control circuit 120 generates the positive pulse signal corresponding to a single voltage pulse. Unlike the second embodiment, the driver unit does not include the single voltage pulse generator or the dual voltage pulse generator, thereby further simplifying the configuration.

Since the positive pulse signal from the output terminal of the control circuit 120 and the output signal from the output terminal of the inverter circuit 150 are positive voltage pulse signals having a phase difference of 90 degree, the 3D image display panel driving signal 3D_DRIVE as a differential signal therebetween has the waveform shown in FIG. 5, similarly to the first embodiment.

According to the third embodiment of the invention, the voltage +V and the voltage −V can be generated without using a dual power supply unit, thereby obtaining the same advantages as the first and second embodiments.

On the other hand, in the third embodiment of the invention, the 2D/3D image display switching signal 2D/3D_CONVERT can be supplied to the driver unit 100 or the 3D image display panel 200, similarly to the first embodiment.

### INDUSTRIAL APPLICABILITY

According to the above-mentioned embodiments of the invention, since the dual voltage driving signal can be supplied to the 3D image display panel without using the dual power supply unit, it is possible to reduce the ghost of a 3D image and to enhance the stereoscopic effect of the 3D image. Since the digital control circuit controls directly the output terminals, it is possible to perform an accurate control operation without considering a slew rate in designing a driving circuit. In addition, since only the single power supply unit is used, particularly high precision of the power supply circuit is not needed unlike the case where the dual power supply unit is used, thereby simplifying the circuit configuration and reducing the cost for products.

The exemplary embodiments have been described in the drawings and the specification. While particular terms have been used in the exemplary embodiments, they are used for only explaining the invention, but not for limiting the scope of the invention described in the claims. Therefore, it can be understood by those skilled in the art that the invention can be variously modified and altered without departing from the spirit and scope of the invention described in the attached claims.

1. A driver unit of a 2D/3D image display apparatus including a 3D image display panel,
wherein the driver unit supplies a 3D image display panel driving signal to the 3D image display panel,
wherein the driver unit includes:
a single power supply unit which generates a single source voltage; and
a control circuit which is connected to the single power supply unit and has first and second output terminals connected to the 3D image display panel,
wherein the control circuit outputs first and second positive voltage pulse signals having a phase difference of 90 degree through the first output terminal and the second output terminal, and
wherein the 3D image display panel driving signal is a differential signal between the first and second positive voltage pulse signals.

2. A driver unit of a 2D/3D image display apparatus including a 3D image display panel,
wherein the driver unit supplies a 3D image display panel driving signal to the 3D image display panel,
wherein the driver unit includes:
a single power supply unit which generates a single source voltage;
a control circuit which is connected to the single power supply unit and generates a first pulse signal;
a single voltage pulse generator which is connected to the control circuit, is turned on or off in accordance with the first pulse signal, and generates a second pulse signal as a single positive voltage pulse signal; and
an inverter circuit which is connected to an output terminal of the single voltage pulse generator and inverts the second pulse signal,
wherein the output terminal of the single voltage pulse generator and an output terminal of the inverter circuit are connected to the 3D image display panel, and
wherein the 3D image display panel driving signal is a differential signal between the second pulse signal from the output terminal of the single voltage pulse generator and an output signal from the output terminal of the inverter circuit.

3. A driver unit of a 2D/3D image display apparatus including a 3D image display panel,
wherein the driver unit supplies a 3D image display panel driving signal to the 3D image display panel,
wherein the driver unit includes:
a single power supply unit which generates a single source voltage;
a control circuit which is connected to the single power supply unit and generates a positive pulse signal; and
an inverter circuit which is connected to an output terminal of the control circuit and inverts the positive pulse signal,
wherein the output terminal of the control circuit and an output terminal of the inverter circuit are connected to the 3D image display panel, and
wherein the 3D image display panel driving signal is a differential signal between the positive pulse signal from the output terminal of the control circuit and an output signal from the output terminal of the inverter circuit.

4. The driver unit according to claim 1, wherein the control circuit is supplied with a 2D/3D image display switching signal.

5. The driver unit according to claim 4, wherein the 2D/3D image display switching signal is supplied from a predetermined external device.

6. The driver unit according to claim 1, wherein the 3D image display panel is supplied with a 2D/3D image display switching signal.

7. The driver unit according to claim 6, wherein the 2D/3D image display switching signal is supplied from a predetermined switch.

8. The driver unit according to claim 2, wherein the control circuit is supplied with a 2D/3D image display switching signal.

9. The driver unit according to claim 3, wherein the control circuit is supplied with a 2D/3D image display switching signal.

10. The driver unit according to claim 2, wherein the 3D image display panel is supplied with a 2D/3D image display switching signal.

11. The driver unit according to claim 3, wherein the 3D image display panel is supplied with a 2D/3D image display switching signal.
